(19) United States
(12) Patent Application Publication
(10) Pub. No.: US 2026/0139107 A1
(43) Pub. Date: May 21, 2026

(54) HEAT-SHRINKABLE POLYESTER FILM

(71) Applicants: Bonset America Corporation, Browns Summit, NC (US); C.I. TAKIRON Corporation, Osaka-shi, Osaka (JP)

(72) Inventors: Hideaki TAKAHASHI, Browns Summit, NC (US); Victoria Marie Moncada MEEKS, Browns Summit, NC (US); Yuichiro KANZAKA, Browns Summit, NC (US)

(21) Appl. No.: 19/119,102

(22) PCT Filed: Sep. 22, 2023
(86) PCT No.: PCT/US2023/033420

§ 371 Date: Apr. 8, 2025

Related U.S. Application Data
(60) Provisional application No. 63/420,687, filed on Oct. 31, 2022.

(51) Int. Cl. C08J 5/18; C08L 67/02

(52) U.S. Cl. CPC C08J 5/18; C08L 67/02; C08J 2367/02; C08J 2467/02; C08L 2203/162; C08L 2205/025

(57) ABSTRACT

A heat-shrinkable polyester film having an improved recyclability and excellent attachment and appearance is provided. The heat-shrinkable polyester film, having a property (A) in which a clumping fraction of a polyester resin or the like is 1.2% or less, a property (B) in which a melting point is 190° C. to 230° C., a property (C) in which a melting heat quantity is 25 to 45 mJ/mg, and properties (D1) to (D4) in which a thermal shrinkage ratio in a main shrinkage direction measured under thermal shrinkage conditions at 60° C., 70° C., and 80° C. for 10 seconds is 0 to 5%, 25 to 50%, 55 to 85%, and a standard deviation of the value of the thermal shrinkage ratio measured at 95° C. to 100° C. for 10 seconds is 1.5% or less.

### TECHNICAL FIELD

The present invention relates to a heat-shrinkable polyester film (sometimes called as a polyester-based shrink film etc.).

More specifically, the present invention relates to a heat-shrinkable polyester film which has a good balance between recyclability and thermal shrinkability, which can be recycled together with used PET bottles to which it is still attached and which has excellent attachment and appearance due to correction of an obtained thermal shrinkage ratio even with slight changes in a thermal shrinkage temperature or the like.

### BACKGROUND ART

Conventionally, polyethylene resin (HDPE) bottles and polyester resin (PET) bottles (hereinafter sometimes simply referred to as PET bottles) have been used as beverage storage containers, detergent storage containers, and the like.

Particularly, PET bottles are widely used worldwide as beverage storage containers because they are lightweight, have excellent durability, and are very convenient.

On the other hand, such PET bottles are discarded in rivers after use, and flow into the ocean and the like, causing serious environmental problems.

Therefore, in order to solve such environmental problems, research on such PET bottle recovery and recycling technologies is being actively carried out.

Here, PET bottles are wrapped with a predetermined display label in order to indicate various information related to the name and contents and to improve decorativeness and the like.

That is, as a display label, a display label using a heat-shrinkable polyester film that is wrapped around the entire surface of the PET bottle is mainstream.

More specifically, in order to obtain favorable thermal shrinkability, heat-shrinkable polyester films derived from amorphous polyester resins (PETG) are often used.

However, as thermal properties of PETG, not having a melting point, in a process of recycling PET bottles wrapped with a heat-shrinkable film, there is a problem in which recycled pellets tend to adhere to each other.

That is, when PET bottles wrapped with a heat-shrinkable film are thermally melted in the recycling process, as shown in FIG. 11A, there is a problem in which, due to the heat-shrinkable film, recycled pellets containing the heat-shrinkable film adhere to each other and form clumps, which cause clogging within pipes.

Therefore, inherently, there is a problem in which, when PET bottles including a heat-shrinkable film are melted, the obtained recycled pellets do not adhere to each other, and it is difficult to effectively and stably produce pellets having a predetermined shape using a pelletizer as shown in FIG. 11B.

Therefore, in order to achieve various objectives, in consideration of recyclability, a heat-shrinkable polyester film derived from a crystalline polyester resin having a predetermined melting point has been proposed (Patent Documents 1 and 2).

That is, Patent Document 1 discloses a heat-shrinkable polyester film for the purpose of obtaining excellent recyclability and the like while reducing adverse effects of residual ink.

More specifically, for example, in the heat-shrinkable polyester film, during a heat treatment at 80° C. for 10 seconds, the thermal shrinkage ratio in the main shrinkage direction is 30% or more, and the melting point measured using differential scanning calorimetry (hereinafter sometimes simply referred to as DSC) is in a range of 170° C. to 230° C.

Here, Patent Document 2 also discloses a heat-shrinkable polyester film for the purpose of obtaining excellent recyclability and the like.

More specifically, as shown in FIGS. 12A to 12B, the invention is intended to control the clumping fraction measured under predetermined conditions to be 10% or less, and to control the melting point and the crystallization temperature of the heat-shrinkable polyester film, as shown by property curves L6 and L6′.

Here, for example, in the heat-shrinkable polyester film, the thermal shrinkage ratio in the main shrinkage direction at 70° C. for 10 seconds is set to 0% to 50%, the thermal shrinkage ratio in the main shrinkage direction at 80° C. for 10 seconds is set to 30% to 85%, the thermal shrinkage ratio in the main shrinkage direction at 100° C. for 10 seconds is limited to being within a range of 40 to 90%, and the melting point is limited to being within a range of 170° C. to 240° C.

On the other hand, Patent Document 3 discloses a heat-shrinkable polyester film for the purpose of improving printing processability and the like of heat-shrinkable polyester films, limiting a rate in the change of the thermal shrinkage ratio for each predetermined temperature range, and exhibiting excellent finishing when it is attached to a PET bottle or the like.

More specifically, in the heat-shrinkable polyester film, the rate of change (%/° C.) of the thermal shrinkage ratio in the main shrinkage direction depending on the temperature is 1.5 to 3.0 in a range of 60° C. to 70° C., 2.5 to 3.5 in a range of 70° C. to 80° C., 1.0 to 2.0 in a range of 80° C. to 90° C., and 0.1 to 1.0 in a range of 90° C. to 100° C.

### CITATION LIST

### Patent Document

Patent Document 1: JP 2020-521823 A (claims and the like)
Patent Document 2: JP 2022-510146 A (claims and the like)
Patent Document 3: JP 2011-184690 A (claims and the like)

### SUMMARY OF THE INVENTION

### Problem to be Solved by the Invention

However, the heat-shrinkable polyester films disclosed in Patent Document 1 and Patent Document 2 have a problem in which, while the values of the aggregation fraction and the clumping fraction measured under respective predetermined conditions are a predetermined value or less, and a certain degree of recyclability is obtained, the value of the thermal shrinkage ratio in the predetermined temperature range tends to vary.

That is, since a crystalline polyester resin having a melting point in a wide range is used, there is a problem in which, in a predetermined temperature range (60° C. to 100° C.), particularly in a temperature range around 70° C., the value of the thermal shrinkage ratio tends to vary.

Therefore, spots, wrinkles, and the like are likely to occur during thermal shrinkage, the appearance and attachment are poor, and thus a favorable balance between recyclability and thermal shrinkability of the heat-shrinkable polyester film has not yet been achieved.

On the other hand, when the heat-shrinkable polyester film disclosed in Patent Document 3 is recycled while attached to used PET bottles without considering the clumping fraction measured under predetermined conditions, there is a problem in which a sticking phenomenon (interlocking phenomenon) is likely to occur.

Moreover, all examples (Examples 1 to 4) have a problem in which the value of the thermal shrinkage ratio at 70° C. for 10 seconds is in a range of about 15 or more and less than 30%, which is considerably low, usability as a heat-shrinkable polyester film is poor and a stable thermal shrinkability cannot be obtained.

Thus, the inventors of the present invention conducted extensive studies in order to address the above problems, and as a result, found that, in a heat-shrinkable polyester film derived from a polyester resin, when at least predetermined properties (A) to (B) of a raw material resin such as a clumping fraction and predetermined properties (C), (D1) to (D4) of a heat-shrinkable polyester film are controlled, conventional problems can thus be solved.

That is, an objective of the present invention is to provide a heat-shrinkable polyester film which allows pellets having a predetermined shape to be effectively and stably produced even if PET bottles covered with a heat-shrinkable polyester film are recycled together, and consequently, even if a thermal shrinkage temperature and the like change, and a thermal shrinkage ratio does not fall within a desired range, correction is performed and the film has excellent attachment and appearance.

### Means for Solving Problem

According to the present invention, there is provided a heat-shrinkable polyester film derived from a polyester resin which is a reaction product of a polycarboxylic acid and a polyalcohol, having the following properties (A) to (C) and (D1) to (D4), and the above problems can be solved.
(A) A clumping fraction in a mixture of the polyester resin and other PET resins, which is measured according to APR Document Code: PET-S-08, (hereinafter sometimes simply referred to as a clumping fraction) is a value of 1.2% or less.
(B) The melting point of the polyester resin measured through DSC is a value in a range of 190° C. to 230° C.
(C) A melting heat quantity of the heat-shrinkable polyester film corresponding to a melting peak area at a melting point measured through DSC is a value in a range of 25 to 45 mJ/mg.
(D1) A thermal shrinkage ratio in the main shrinkage direction measured under thermal shrinkage conditions of 60° C. and for 10 seconds is a value in a range of 0 to 5%.
(D2) A thermal shrinkage ratio in the main shrinkage direction measured under thermal shrinkage conditions of 70° C. and for 10 seconds is a value in a range of 25 to 50%.
(D3) A thermal shrinkage ratio in the main shrinkage direction measured under thermal shrinkage conditions of 80° C. and for 10 seconds is a value in a range of 55 to 85%.
(D4) A standard deviation of the value of the thermal shrinkage ratio in the main shrinkage direction measured under thermal shrinkage conditions of 95° C. to 100° C. and for 10 seconds is a value of 1.5% or less.

That is, when the configurations (A) to (C) and (D1) to (D4) are satisfied in this manner, in a polyester resin into which other PET resins (recycled PET resins, etc.), are mixed, which is a raw material resin of a heat-shrinkable polyester film, by controlling the clumping fraction measured under certain conditions, and the melting point of the polyester resin as a raw material resin, and additionally the melting heat quantity, and the thermal shrinkage ratio at a predetermined temperature, to be within predetermined ranges, a good balance between recyclability and thermal shrinkability can thus be achieved.

Therefore, the heat-shrinkable polyester film can be recycled together with predetermined PET bottles to which it is still attached, and even if the thermal shrinkage temperature and the like change from relatively low temperature conditions to high temperature conditions, and the thermal shrinkage ratio does not fall within a desired range, it is possible to perform correction and provide a heat-shrinkable polyester film having excellent attachment and appearance.

Here, when the heat-shrinkable polyester film of the present invention is formed, as a property (D4′), the thermal shrinkage ratio in the main shrinkage direction (TD direction) measured under thermal shrinkage conditions of 95° C. to 100° C. and for 10 seconds is preferably a value of 70% or more.

When the thermal shrinkage ratio in a high temperature range is also controlled in this manner, it becomes easier to control the value of the thermal shrinkage ratio in a relatively low temperature range of 60° C. to 80° C. to be within a desired range accordingly, and consequently, it is possible to further improve the attachment and appearance when the film is thermally shrunk.

Here, when the heat-shrinkable polyester film of the present invention is formed, as a property (D5), the thermal shrinkage ratio in the main shrinkage direction (TD direction) measured under thermal shrinkage conditions of 60° C. to 80° C. and for 10 seconds preferably satisfies the following Relational Expression (1).

In this manner, in a predetermined temperature range, when the thermal shrinkage temperature and the thermal shrinkage ratio satisfy predetermined Relational Expression (1), it is possible to linearly control these values.

Therefore, even if the thermal shrinkage temperature or the like changes, and the thermal shrinkage ratio does not fall within a desired range while favorable recyclability is maintained, it is possible to perform correction and obtain favorable thermal shrinkability accurately.

$$[ Math . 1 ]$$

$$Thermal shrinkage ratio ( \% ) = a \times ( thermal shrinkage temperature ( ° C . ) - 60 ) + b \qquad ( 1 )$$

a: corresponding to a slope of Relational Expression (1), a value of 3.25 or more and 4 or less
b: corresponding to a constant of Relational Expression (1), a value of 0 or more and 5 or less

Here, when the heat-shrinkable polyester film of the present invention is formed, as a property (D5′), the thermal shrinkage ratio in the main shrinkage direction (TD direction) measured under thermal shrinkage conditions of 60° C. to 80° C. and for 10 seconds preferably satisfies the following Relational Expression (2).

In this manner, in a predetermined temperature range, when the thermal shrinkage temperature and the thermal shrinkage ratio satisfy predetermined Relational Expression (2), it is possible to linearly control these values within a narrower range while favorable recyclability is maintained.

$$[ Math . 2 ]$$

$$Thermal shrinkage ratio ( \% ) = {a}^{′} \times ( thermal shrinkage temperature ( ° C . ) - 60 ) + {b}^{′} \qquad ( 2 )$$

a′: corresponding to a slope of Relational Expression (2), a value of 3.3 or more and 3.75 or less
b′: corresponding to a constant of Relational Expression (2), a value of 0 or more and 5 or less

Here, when the heat-shrinkable polyester film of the present invention is formed, as a property (D5″), the thermal shrinkage ratio in the main shrinkage direction (TD direction) measured under thermal shrinkage conditions of 60° C. to 80° C. and for 10 seconds preferably satisfies the following Relational Expression (3).

In this manner, in a predetermined temperature range, when the thermal shrinkage temperature and the thermal shrinkage ratio satisfy predetermined Relational Expression (3), it is possible to linearly control these values within a narrower range.

$$[ Math . 3 ]$$

$$Thermal shrinkage ratio ( \% ) = {a}^{′′} \times ( thermal shrinkage temperature ( ° C . ) - 60 ) + {b}^{′′} \qquad ( 3 )$$

a″: corresponding to a slope of Relational Expression (3), a value of 3.35 or more and 3.5 or less
b″: corresponding to a constant of Relational Expression (3), a value of 0 or more and 5 or less

Here, when the heat-shrinkable polyester film of the present invention is formed, as a property (D6), the thermal shrinkage ratio in the direction (MD direction) perpendicular to the main shrinkage direction measured under thermal shrinkage conditions of 70° C. and for 10 seconds is preferably a value in a range of −3 to 5%.

When the thermal shrinkage ratio in the MD direction under predetermined temperature conditions is limited in this manner, even if the periphery of the PET bottle is covered and the PET bottle is thermally shrunk at a relatively low temperature, the attachment and appearance are improved, and as a result, deformation of text, figures, and the like is reduced and accurate information and the like can be easily obtained.

Moreover, when the thermal shrinkage ratio in the MD direction is limited in this manner, the thermal shrinkability of the entire heat-shrinkable polyester film is balanced, and even if the film is recycled together with PET bottles, it is possible to stably obtain pellets by controlling the stickiness, fluidity, and the like.

Here, when the heat-shrinkable polyester film of the present invention is formed, it is preferable to set the average thickness of the film to a value in a range of 10 to 100 μm and the standard deviation of the average thickness measured under predetermined conditions to a value of 1.7 μm or less.

When the film thickness and the standard deviation as its variation are limited in this manner, the balance between recyclability and thermal shrinkability is further improved, and thus a heat-shrinkable polyester film having an accurately controlled thermal shrinkability, transparency, and also an excellent mechanical property and the like can be obtained.

Here, when the heat-shrinkable polyester film of the present invention is formed, the polyester resin is a mixture of a crystalline polyester resin and an amorphous polyester resin, and the weight mixing ratio is preferably a value in a range of 100:0 to 80:20.

When the weight mixing ratio is controlled in this manner, the balance between recyclability and thermal shrinkability is further improved, and thus a heat-shrinkable polyester film having an accurately controlled thermal shrinkability, attachment, appearance, transparency, and also an excellent mechanical property and the like can be obtained.

### BRIEF DESCRIPTION OF DRAWINGS

FIGS. 1A to 1C are diagrams for illustrating forms of a heat-shrinkable polyester film.

FIG. 2A is a diagram provided for illustrating the relationship between a maximum stretching rate when a heat-shrinkable polyester film is produced and a standard deviation of a thermal shrinkage ratio in a main shrinkage direction at 100° C. for 10 seconds, and FIG. 2B is a diagram similarly provided for illustrating the relationship between a maximum stretching rate and a standard deviation of the thickness.

FIG. 3 is a diagram provided for illustrating the relationship between a standard deviation of a thermal shrinkage ratio in a main shrinkage direction at 100° C. for 10 seconds in a heat-shrinkable polyester film produced at a predetermined maximum stretching rate and evaluation of a clumping fraction (relative value).

FIG. 4 is a diagram provided for illustrating the relationship between a maximum stretching rate and a crystallization heat quantity when a heat-shrinkable polyester film is produced.

FIG. 5 is a diagram provided for illustrating the relationship between a maximum stretching rate when a heat-shrinkable polyester film is produced and a glass transition temperature of the heat-shrinkable polyester film.

FIG. 6 is a diagram provided for illustrating the relationship between a maximum stretching rate and a melting heat quantity.

FIG. 7 is a diagram provided for illustrating a region (S1) defined by Relational Expression (1) in the present invention.

FIG. 8 is a diagram provided for illustrating a region (S2) defined by Relational Expression (2) in the present invention.

FIG. 9 is a diagram provided for illustrating a region (S3) defined by Relational Expression (3) in the present invention.

FIG. 10A is a DSC chart of a heat-shrinkable polyester film in Example 1 and FIG. 10B is a DSC chart of a polyester resin (PET2) used when a clumping fraction is measured in Example 1 and the like.

FIG. 11A is a schematic view showing an adhesion state of a PET bottle covered with a conventional heat-shrinkable polyester film, and FIG. 11B is a schematic view showing a recycled PET resin obtained in a recycling process, which is derived from the PET bottle covered with the heat-shrinkable polyester film of the present invention.

FIG. 12A is a diagram showing the relationship between a clumping fraction and a melting point in Patent Document 2 (Conventional Technique 2), and FIG. 12B is a diagram showing the relationship between a clumping fraction and a crystallization heat quantity in Patent Document 2.

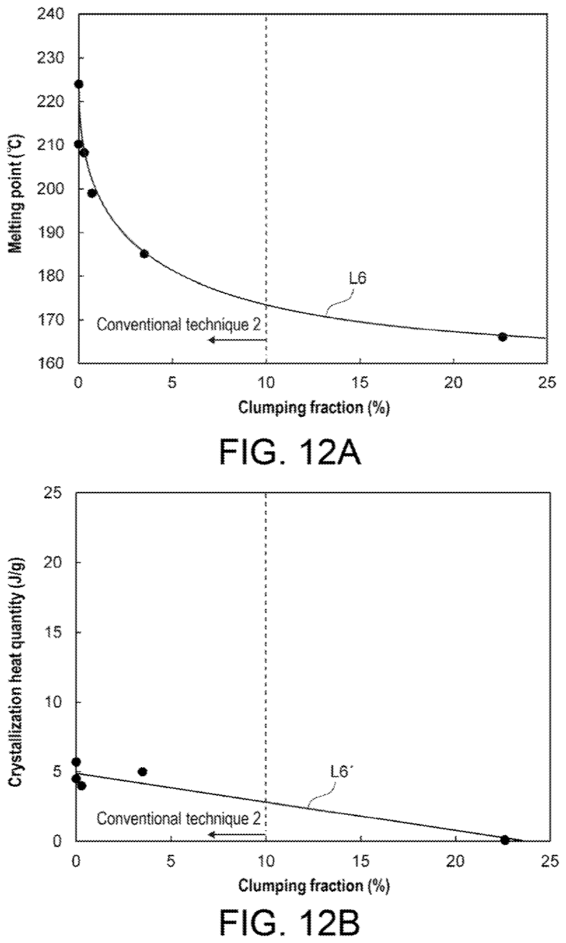

### MODE(S) FOR CARRYING OUT THE INVENTION

### First Embodiment

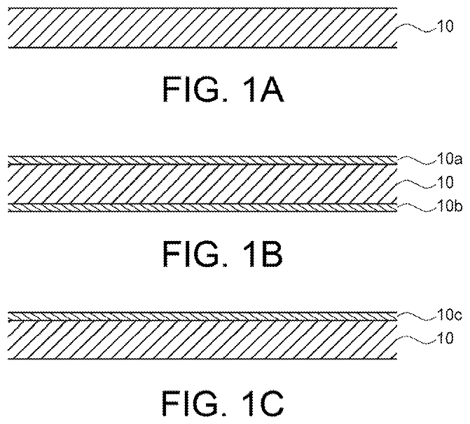

As illustrated in FIGS. 1A to 1C, a first embodiment is a heat-shrinkable polyester film derived from a polyester resin which is a reaction product of a polycarboxylic acid and a polyalcohol.

Therefore, a heat-shrinkable polyester film that satisfies the following properties (A) to (C) and (D1) to (D4) is provided.
(A) a clumping fraction in a mixture of the polyester resin and other PET resins, which is measured according to APR Document Code: PET-S-08, is a value of 1.2% or less.
(B) the melting point of the polyester resin measured through DSC is a value in a range of 190° C. to 230° C.
(C) a melting heat quantity of the heat-shrinkable polyester film corresponding to a melting peak area at a melting point measured through DSC is a value in a range of 25 to 45 mJ/mg.
(D1) a thermal shrinkage ratio in the main shrinkage direction measured under thermal shrinkage conditions of 60° C. and for 10 seconds is a value in a range of 0 to 5%.
(D2) a thermal shrinkage ratio in the main shrinkage direction measured under thermal shrinkage conditions of 70° C. and for 10 seconds is a value in a range of 25 to 50%.
(D3) a thermal shrinkage ratio in the main shrinkage direction measured under thermal shrinkage conditions of 80° C. and for 10 seconds is a value in a range of 55 to 85%.
(D4) a standard deviation of the value of the thermal shrinkage ratio in the main shrinkage direction measured under thermal shrinkage conditions of 95° C. to 100° C. and for 10 seconds is a value of 1.5% or less.

Hereinafter, the heat-shrinkable polyester film of the first embodiment will be described in detail by dividing it into components with appropriate reference to the drawings.

### 1. Polycarboxylic Acid

A polycarboxylic acid, which is one constituent component (raw material component) of a polyester resin, is not particularly limited as long as it is a compound that can react with a polyalcohol and form a polyester structure, and examples thereof include at least one of fatty dicarboxylic acids such as adipic acid, sebacic acid, and azelaic acid, aromatic dicarboxylic acids such as terephthalic acid, naphthalenedicarboxylic acid, and isophthalic acid, alicyclic dicarboxylic acids such as 1,4-cyclohexanedicarboxylic acid, and ester-forming derivatives thereof.

Particularly, terephthalic acid is preferable because it has favorable reactivity with a polyalcohol, easily forms a crystalline polyester structure, is relatively inexpensive, and is also economically advantageous.

Therefore, when the total amount of polycarboxylic acid to be used is 100 mol %, the amount of terephthalic acid used is preferably a value of 90 mol % or more and more preferably a value in a range of 95 to 100 mol %.

### 2. Polyalcohol

### (1) Type

Here, a polyalcohol, which is one constituent component of a polyester resin, is not particularly limited as long as it is a compound having a plurality of reactive hydroxyl groups, and for example, it is preferable to mix at least one of aliphatic diols such as ethylene glycol, diethylene glycol, propane diol, butane diol, neopentyl glycol, and hexane diol, alicyclic diols different from 1,4-cyclohexanedimethanol, and aromatic diols.

This is because, when such a polyalcohol is used, it is appropriately reacted with a polycarboxylic acid, and it is easy to obtain a polyester resin in which crystallinity and the like are controlled to be within a predetermined range.

Here, among these polyalcohols, it is more preferable to use one or more diols selected from among ethylene glycol, diethylene glycol, neopentyl glycol, and the like.

That is, this is because, when these specific polyalcohols are used, the melting point, thermal shrinkage ratio, thermal shrinkage stress, and the like of the polyester resin obtained by reacting with a polycarboxylic acid can be more easily adjusted to values in a predetermined range.

Therefore, when the total amount of polyalcohol to be used is 100 mol %, the amount of one or more diols used selected from among ethylene glycol, diethylene glycol, neopentyl glycol, and the like is preferably a value of 90 mol % or more and more preferably a value in a range of 95 to 100 mol %.

Here, as necessary, other dicarboxylic acids and diols, or hydroxycarboxylic acid may be used in order to change thermal properties and mechanical properties of the heat-shrinkable polyester film, and these may be used alone or in combination as a mixture.

### (2) Reaction Amount

Here, the reaction amount of the polyalcohol is also not particularly limited, and generally, it is preferable to react 100 mol of a polycarboxylic acid containing 80 mol % or more of terephthalic acid and the like with 130 to 220 mol of a polyalcohol, more preferable to react it with 150 to 210 mol of a polyalcohol, and still more preferable to react it with 180 to 200 mol of a polyalcohol, and a polyester resin obtained by crystallizing these reaction products is preferable.

In this case, as a crystallinity indicator of a polyester resin, the degree of crystallization calculated from the DSC curve measured according to JIS K 7122:2012 is preferably a value in a range of 1 to 15%, more preferably a value in a range of 2 to 10%, and still more preferably a value in a range of 3 to 8%.

That is, in such a DSC curve, from the melting heat quantity (ΔHm) obtained from the melting peak area and the crystallization heat quantity (ΔHc) obtained from the crystallization peak area and the complete crystallization heat quantity (ΔHm⁰) of crystallized polyethylene terephthalate, the degree of crystallization of the polyester resin can be calculated according to the following formula (4).

$$[ Math . 4 ]$$

$$Degree of crystallization {( \% )}^{-} \frac{Δ Hm - Δ Hc}{Δ {Hm}^{0}} \times 100 \qquad ( 4 )$$

ΔHm: melting heat quantity (J/g)
ΔHc: crystallization heat quantity (J/g)
ΔHm⁰: 140.1 J/g (complete crystallization heat quantity of crystallized polyethylene terephthalate)

### 3. Polyester Resin

### (1) Clumping Fraction

As the property (A) of the polyester resin as a raw material resin constituting the heat-shrinkable polyester film, a clumping fraction of a polyester resin or the like, which is a mixture of a polyester resin and other PET resins, measured according to APR Document Code: PET-S-08, is a value of 1.2% or less.

The reason for this is that, when the clumping fraction is more than 1.2%, the recyclability may significantly decrease, and the variation in the thermal shrinkage ratio may increase. As a result, it becomes difficult to suppress the occurrence of spots, wrinkles, and the like during thermal shrinkage when the thermal shrinkage temperature slightly changes and to maintain favorable attachment.

However, when the clumping fraction is set to an excessively small value, the yield may significantly decrease, or the types of mixing components used in the polyester resin and the like may be excessively limited.

Therefore, the clumping fraction of the polyester resin or the like is more preferably a value in a range of 0.01 to 1% and still more preferably a value in a range of 0.1 to 0.8%.

Here, in the case of conventional polyester resins, it can be said that the heat-shrinkable polyester film formed therefrom has, for example, a thermal shrinkage ratio at 70° C. for 10 seconds that is preferably in a range of 0% to 50%, and therefore the melting point varies greatly and an S-shaped property curve is easily changed.

Therefore, in the case of heat-shrinkable polyester films derived from conventional polyester resins, even if the thermal shrinkage temperature varies and a desired thermal shrinkage ratio cannot be obtained, it cannot be corrected quickly and accurately.

On the other hand, in the case of the present invention, since the thermal shrinkage temperature and the thermal shrinkage ratio change linearly, even when the thermal shrinkage temperature varies and a desired thermal shrinkage ratio cannot be obtained temporarily, by controlling the clumping fraction of the polyester resin or the like and according to Relational Expressions (1) to (3) to be described below, a desired thermal shrinkage ratio can be stably obtained.

Here, the clumping fraction of the polyester resin or the like according to APR Document Code: PET-S-08 can be measured under the following measurement conditions.
1) An oven is preheated to 210° C.
2) Next, PET flakes (corresponding to a mixture of a polyester resin and other PET resins) having an initial weight (1 kg) obtained by washing, levigating, and crystallizing a PET bottle or the like with a heat-shrinkable polyester film attached thereto are accommodated in a 22×33 cm baking pan lined with an aluminum foil.
3) Next, the PET flakes accommodated in the baking pan are heated for 90 minutes using an oven maintained at a predetermined temperature.
4) Next, the baking pan is removed from the oven, and directly cooled to room temperature.
5) The PET flakes are removed from the baking pan, and accommodated in a sieve with a stainless steel mesh having an opening of 12.5 mm.
6) The sieve in which PET flakes are accommodated is vibrated by hand until all the PET flakes are sieved. Then, PET flakes that pass through the mesh are recovered below. Here, PET flakes (aggregates) that cannot pass through the mesh and remain on the mesh are appropriately removed.
7) The weight of aggregates that cannot pass through the mesh is weighed. Here, PET flakes adhered to the aluminum foil and the residue are separately weighed.
8) The clumping fraction is calculated from the weights of weighed PET flakes (aggregates) that cannot pass through the mesh, the residue, and the like with respect to the initial weight (1 kg).

### (2) Melting Point

Here, as the property (B), the melting point of the polyester resin which is the raw material resin of the heat-shrinkable polyester film is defined as the temperature indicating the maximum value of the melting peak in the DSC curve, which is a value in a range of 190° C. to 230° C.

The reason for this is that, when the melting point is a value lower than 190° C., a display label using the heat-shrinkable polyester film may easily melt in the drying process when PET bottles are recycled. As such, pieces of recycled PET bottles may adhere and aggregate (agglomerate) accordingly.

On the other hand, this is because, when the melting point is a value of higher than 230° C., the heat quantity required for extrusion and stretching processings of the raw sheet of the heat-shrinkable polyester film used for the label becomes too high, and processing may become difficult.

Therefore, the melting point of the polyester resin is more preferably a value in a range of 195° C. to 225° C. and still more preferably a value in a range of 200° C. to 220° C.

That is, it is also important to control the value of the melting point of the polyester resin, but when the range (difference between the maximum value and the minimum value) is set to 25° C. or lower or more preferably set to 15° C. or lower, even if the crystalline polyester resin is used as the main component (for example, 80 wt % or more), the balance between recyclability and thermal shrinkability is further improved.

Here, the melting point of the polyester resin can be measured, for example, as a melting peak temperature (Tpm) which is a peak temperature of the melting heat exhibited in an endothermic reaction, in the profile obtained using DSC (hereinafter the same applies).

Here, the crystallinity of the polyester resin can be estimated from the area (peak area), the half width, or the like in the peak of the melting heat.

### (3) Average Molecular Weight

Here, the intrinsic viscosity (IV value) as the average molecular weight of the polyester resin is preferably a value in a range of 0.65 to 0.85 dL/g.

The reason for this is that, when the intrinsic viscosity is a value of less than 0.65 dL/g, the melt viscosity is too low, which may cause problems in extrusion moldability.

On the other hand, when the intrinsic viscosity is a value of more than 0.85 dL/g, the melt viscosity is too high, which may also cause problems in extrusion moldability.

Therefore, the intrinsic viscosity is more preferably a value in a range of 0.68 to 0.83 dL/g and still more preferably a value in a range of 0.7 to 0.8 dL/g.

That is, it is also important to control the value of the intrinsic viscosity of the polyester resin, but when the range (difference between the maximum value and the minimum value) is set to 0.15 dL/g or less, even if the crystalline polyester resin is used as the main component (for example, 80 wt % or more), the balance between recyclability and thermal shrinkability is further improved.

Here, the intrinsic viscosity of the polyester resin can be measured according to JIS K 7390 (hereinafter the same applies).

### (4) Additives

Here, it is preferable to mix additives such as an antioxidant, a weathering stabilizer, an antistatic agent, an anti-fog additive, a metallic soap, a wax, a fungicide, an antibacterial agent, a nucleating agent, a flame retardant, and a slipping agent into the polyester resin as necessary.

Particularly, in order to improve slipperiness on the film surface, for example, an inorganic slipping agent such as calcium carbonate particles, silica particles, and glass particles in a range of 0.01 to 10 wt % is preferably mixed in with respect to a total amount (100 wt %) of the film.

Here, a method of adding an additive is not particularly limited, and known methods can be used. However, addition by a masterbatch is preferable because it is simple and excellent in uniform mixing.

For example, specific examples (commercial product) of polyester resin masterbatches when an anti-blocking agent is mixed include Anti-Blocking Agent (Contains: 20% Silica, Sukano, product name: G dc S559-E).

In addition, it is also preferable to mix other resins as long as physical properties of the heat-shrinkable film, particularly a shrinkage rate and a thermal shrinkage stress, are not impaired.

### (5) Mixture

Here, the polyester resin as the raw material resin of the heat-shrinkable polyester film is a mixture of the crystalline polyester resin and the amorphous polyester resin, and the weight mixing ratio is preferably a value in a range of 100:0 to 80:20.

The reason for this is that, when the weight mixing ratio exceeds 80:20, the balance between recyclability and thermal shrinkability becomes poor, recycled PET cannot be stably obtained, and the thermal shrinkage ratio may vary greatly within a desired temperature range.

That is, it is generally said that, when the amount of the amorphous polyester resin mixed with respect to a total amount (100 wt %) of the polyester resin is a value of at least 60 wt % or more, favorable shrinkage cannot be obtained.

However, in the case of the present invention, even if the amount of the amorphous polyester resin mixed with respect to a total amount (100 wt %) of the polyester resin is a value of 20 wt % or less, favorable thermal shrinkability can be obtained in consideration of the clumping fraction of the polyester resin, the melting point and its variation, the melting heat quantity and its variation, the average molecular weight (intrinsic viscosity and its variation) and additionally, stretching conditions during production (a stretching temperature, a stretching magnification, a thermal process temperature, etc.).

Therefore, the weight mixing ratio in the mixture of the crystalline polyester resin and the amorphous polyester resin is more preferably a value in a range of 99:1 to 85:15 and still more preferably a value in a range of 98:2 to 90:10.

### 4. Melting Heat Quantity (ΔHm)

As the property (C) of the heat-shrinkable polyester film, the melting heat quantity (may be described as ΔHm) of the heat-shrinkable polyester film corresponding to the melting peak area at a melting point measured through DSC is a value in a range of 25 to 45 mJ/mg.

The reason for this is that, when the melting heat quantity of the heat-shrinkable polyester film is a value of less than 25 mJ/mg, since crystallization will become insufficient, the heat resistance may significantly decrease, and the heat-shrinkable polyester film may easily melt.

On the other hand, this is because, when the melting heat quantity of the heat-shrinkable polyester film is a value of more than 45 mJ/mg, crystallization is sufficient, but the heat quantity required for extrusion and stretching processings of the raw sheet of the heat-shrinkable polyester film is too high, and it may become difficult to control production conditions.

Therefore, the melting heat quantity of the heat-shrinkable polyester film is more preferably a value in a range of 28 to 40 mJ/mg and still more preferably a value in a range of 30 to 35 mJ/mg.

### 5. Thermal Properties

### (1) Thermal Shrinkage Ratio D1 Under Predetermined Measurement Conditions (60° C., etc.)

As the property (D1) of the heat-shrinkable polyester film, a thermal shrinkage ratio in the main shrinkage direction measured under thermal shrinkage conditions of 60° C. and for 10 seconds is a value in a range of 0 to 5%.

The reason for this is that, when the thermal shrinkage ratio measured under thermal shrinkage conditions of 60° C. and for 10 seconds is more than 5%, the storage period of the heat-shrinkable polyester film is shortened, or storage conditions should be strictly controlled in some cases.

On the other hand, this is because, when the thermal shrinkage ratio is minus %, functions of the heat-shrinkable film may not be exhibited at all, and the mixing amount and the mixing ratio of raw material components that can be used may be strictly limited.

Therefore, regarding the property (D1), the thermal shrinkage ratio in the main shrinkage direction, which is measured under thermal shrinkage conditions of 60° C. and for 10 seconds, is preferably a value in a range of 0.1 to 4.5% and more preferably a value in a range of 0.5 to 4%.

### (2) Thermal Shrinkage Ratio D2 Under Predetermined Measurement Conditions (70° C., etc.)

As the property (D2) of the heat-shrinkable polyester film, a thermal shrinkage ratio in the main shrinkage direction measured under thermal shrinkage conditions of 70° C. and for 10 seconds is a value in a range of 25 to 50%.

The reason for this is that, when the thermal shrinkage ratio is a value of less than 25%, functions of the heat-shrinkable film may not be stably exhibited, and the mixing amount and the mixing ratio of raw material components that can be used may be strictly limited.

On the other hand, this is because, when the thermal shrinkage ratio is more than 50%, the storage period of the heat-shrinkable polyester film is shortened, or storage conditions should be strictly controlled, and additionally, spots, wrinkles, and the like may easily occur when attached to PET bottles.

Therefore, regarding the property (D2), the thermal shrinkage ratio in the main shrinkage direction measured under thermal shrinkage conditions of 70° C. and for 10 seconds is preferably a value in a range of 30 to 45% and more preferably a value in a range of 35 to 40%.

### (3) the Thermal Shrinkage Ratio D3 Under Predetermined Measurement Conditions (80° C., etc.)

As the property (D3) of the heat-shrinkable polyester film, the thermal shrinkage ratio in the main shrinkage direction measured under thermal shrinkage conditions of 80° C. and for 10 seconds is a value in a range of 55 to 75%.

The reason for this is that, when the thermal shrinkage ratio is a value of less than 55%, functions of the heat-shrinkable polyester film may not be stably exhibited and the mixing amount and the mixing ratio of raw material components that can be used may be strictly limited.

On the other hand, this is because, when the thermal shrinkage ratio is more than 75%, the storage period of the heat-shrinkable polyester film is shortened, or storage conditions should be strictly controlled, and additionally, spots, wrinkles, and the like may easily occur when attached to PET bottles.

Therefore, regarding the property (D3), the thermal shrinkage ratio in the main shrinkage direction measured under thermal shrinkage conditions of 80° C. and for 10 seconds is preferably a value in a range of 58 to 72% and more preferably a value in a range of 60 to 70%.

### (4) Thermal Shrinkage Ratio (D4′) Under Predetermined Measurement Conditions (100° C., etc.) and Standard Deviation (D4) Thereof

### (4)-1 Thermal Shrinkage Ratio

As the property (D4′) of the heat-shrinkable polyester film, the thermal shrinkage ratio in the main shrinkage direction (TD direction) measured under thermal shrinkage conditions of 95° C. to 100° C. and for 10 seconds is preferably a value of 70% or more.

The reason for this is that, when the thermal shrinkage ratio in the TD direction under high temperature conditions is limited in this manner, the occurrence of spots, wrinkles, and the like is reduced and consequently, favorable appearance and attachment can be obtained.

That is, even if the periphery of the PET bottle is covered and the PET bottle is thermally shrunk not only under high temperature conditions but also at a relatively low temperature, not only is the attachment improved but the appearance is also improved, and text, figures, and the like laminated on the surface can be recognized with high accuracy.

However, when the thermal shrinkage ratio (D4′) excessively increases, the yield significantly decreases, which will be economically disadvantageous, or the types of mixing components used in the polyester resin may be excessively limited.

Therefore, the thermal shrinkage ratio (D4′) is more preferably a value in a range of 71 to 90% and still more preferably a value in a range of 72 to 85%.

### (4)-2 Standard Deviation of Thermal Shrinkage Ratio

Here, as the property (D4) of the heat-shrinkable polyester film, the standard deviation of the thermal shrinkage ratio in the main shrinkage direction (TD direction) measured under thermal shrinkage conditions of 95° C. to 100° C. and for 10 seconds is a value of 1.5% or less.

The reason for this is that, when the standard deviation of the thermal shrinkage ratio is more than 1.5%, functions of the heat-shrinkable polyester film may not be stably exhibited and the mixing amount and the mixing ratio of raw material components that can be used may be strictly limited.

However, this is because, when the standard deviation of the thermal shrinkage ratio becomes excessively small, the production yield excessively decreases, the types of raw materials that can be used are excessively limited, and additionally, storage conditions should be strictly controlled in some cases.

Therefore, regarding the property (D4), the standard deviation of the thermal shrinkage ratio in the main shrinkage direction (TD direction) measured under thermal shrinkage conditions of 95° C. to 100° C. and for 10 seconds is preferably a value in a range of 0.05 to 1.0% and more preferably a value in a range of 0.1 to 0.8%.

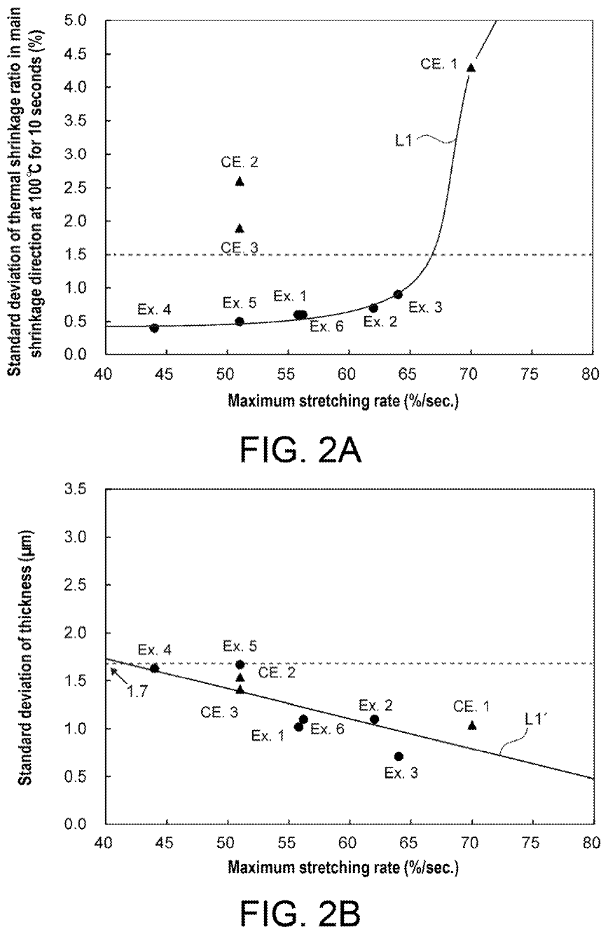

Here, the relationship between the maximum stretching rate when a heat-shrinkable polyester film is produced and the standard deviation of the thermal shrinkage ratio in the main shrinkage direction at 100° C. for 10 seconds will be described with reference to FIG. 2A.

That is, in FIG. 2A, the horizontal axis represents the maximum stretching rate when a heat-shrinkable polyester film is produced, and the vertical axis represents the standard deviation of the thermal shrinkage ratio in the main shrinkage direction measured at 100° C. for 10 seconds.

From a property curve L1 in FIG. 2A, there is a tendency that when the maximum stretching rate passes 40%/sec., and until it reaches about 60%/sec., the standard deviation of the thermal shrinkage ratio to gradually increase in a range of 0.3 to 0.5% is observed. Here, there is a tendency that, when the maximum stretching rate passes 60%/sec. and reaches 67%/sec., the standard deviation of the thermal shrinkage ratio to increase at a considerable proportion and reach a value of about 0.5% to 1.5% is observed. Here, when the maximum stretching rate passes 67%/sec., the standard deviation of the thermal shrinkage ratio increases more rapidly and reaches a value of more than 1.5%.

That is, from the property curve L1, in the case of the heat-shrinkable polyester film of the present invention, it can be understood that, when the maximum stretching rate during production is controlled to be a value in a predetermined range, the standard deviation of the thermal shrinkage ratio measured under predetermined conditions can be stably controlled to be a desired low value.

For example, it can be understood that, when the maximum stretching rate is at least a value in a range of 40 to 67%/sec., the standard deviation of the thermal shrinkage ratio (%) can be controlled to be a small value of 1.5% or less.

Here, the maximum stretching rate is the maximum stretching rate of the film in the main shrinkage direction (TD direction), and is a value defined as the maximum rate when the unstretched film is stretched at different predetermined rates when a heat-shrinkable polyester film is produced.

That is, after stretching of the unstretched film starts, the stretching rate within a few seconds, for example, 0.1 to 12 seconds, becomes maximum, the maximum value of the stretching rate during that period can be regarded as the maximum stretching rate.

Here, the stretching rate in the TD direction can be defined by the following formula.

$$Stretching rate in the TD direction ( \% / sec . ) = ( {W}_{t 2} - {W}_{t 1} ) / {W}_{t 1} \times 100 / ( t 2 - t 1 )$$

Wₜ₁: width (m) of the film t1 seconds after the start of stretching the unstretched film

Wₜ₂: width (m) of the film t2 seconds after the start of stretching the unstretched film

(here, t1<t2, 0≤t1, 0.1≤t2≤12)

However, in the case of Comparative Example 2 and Comparative Example 3 in FIG. 2A, it was found that the clumping fraction is considerably larger than that of the present invention (Example 5, etc.), and it should be noted that, when the clumping fraction is at least 1.2 or less as in the present invention, a property curve L1 is obtained.

On the other hand, as will be described below, when the maximum stretching rate is controlled to be a value in a predetermined range, as shown by the property curve L1′ in FIG. 2B, the standard deviation of the thickness of the heat-shrinkable polyester film can be stably controlled to be a desired value.

That is, it can be understood that, in the case of the property curve L1′, even in the case of Comparative Example 2 and Comparative Example 3 with a high clumping fraction, a favorable correlation with the maximum stretching rate is shown, and the standard deviation of the thickness of the heat-shrinkable polyester film can be controlled to be a predetermined value even if the clumping fraction is not strictly controlled.

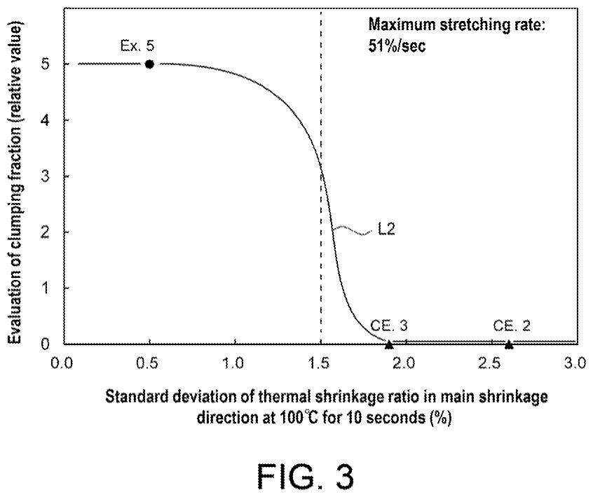

Here, the relationship between the standard deviation of the thermal shrinkage ratio in the main shrinkage direction (TD direction) measured under predetermined thermal shrinkage conditions (at 100° C. for 10 seconds) and evaluation of the clumping fraction will be described with reference to FIG. 3.

That is, the horizontal axis represents the standard deviation of the thermal shrinkage ratio (%) in the main shrinkage direction, and the vertical axis represents the evaluation result (relative value) of the clumping fraction.

It can be said that, from a property curve L2 in FIG. 3, when the standard deviation of the thermal shrinkage ratio in the main shrinkage direction is smaller, the evaluation result (relative value) of the clumping fraction tends to be higher.

More specifically, it can be understood that, when the standard deviation of the thermal shrinkage ratio in the main shrinkage direction is equal to or less than 1.5%, which is a boundary, a high evaluation of at least 3 or more is obtained, and when the standard deviation of the thermal shrinkage ratio (%) is 1% or less, a high evaluation of 5, which is the highest evaluation, is obtained.

On the other hand, when the standard deviation of the thermal shrinkage ratio in the main shrinkage direction is more than 1.5%, the evaluation result of the clumping fraction rapidly decreases, and when the standard deviation is 1.9%, the evaluation result of the clumping fraction is 0, and additionally, when the standard deviation is 2.6%, the evaluation result of the clumping fraction is definitely 0.

Therefore, it can be understood that, as determined from a property curve in FIG. 3, the evaluation result of the clumping fraction can be adjusted by controlling the standard deviation of the thermal shrinkage ratio in the main shrinkage direction.

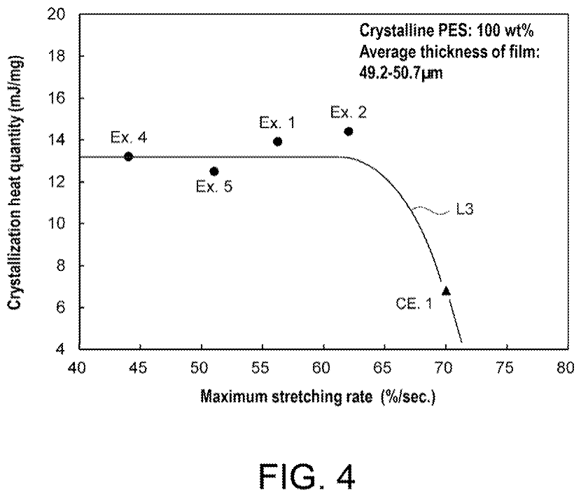

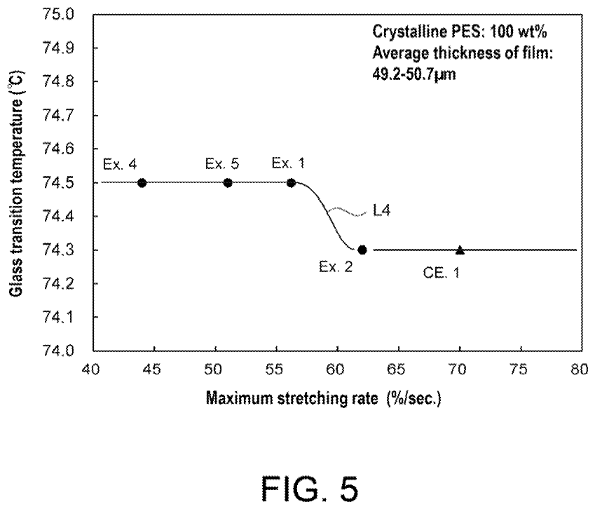

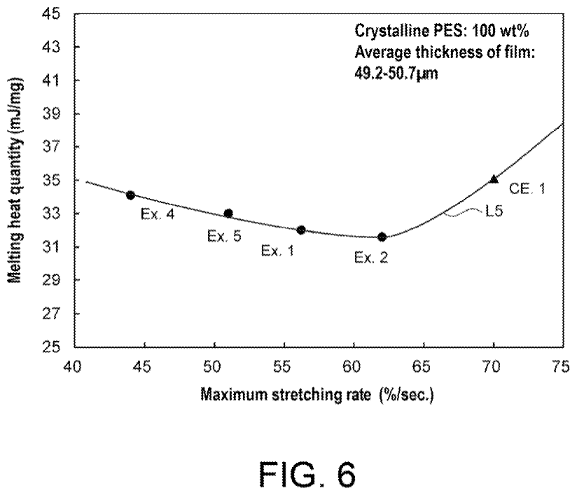

Here, as shown in FIG. 4, FIG. 5, and FIG. 6, it is presumed that the maximum stretching rate when a heat-shrinkable polyester film is produced has a predetermined correlation with each of the crystallization heat quantity, the glass transition temperature, and the melting heat quantity, and this will be described in detail in a production method according to a second embodiment.

### (5) Thermal Shrinkage Ratio D5 Under Predetermined Measurement Conditions

As the property (D5) of the heat-shrinkable polyester film, the thermal shrinkage ratio in the main shrinkage direction (TD direction) measured under thermal shrinkage conditions of 60° C. to 80° C. and for 10 seconds preferably satisfies the following Relational Expression (1).

The reason for this is that, in such a predetermined temperature range, when the thermal shrinkage temperature and the thermal shrinkage ratio satisfy predetermined Relational Expression (1), even if the mixing ratio of the crystalline polyester resin is large, favorable thermal shrinkability can be obtained with high accuracy. Therefore, consequently, it is easy to control a thermal shrinkage force.

$$[ Math . 5 ]$$

$$Thermal shrinkage ratio ( \% ) = a \times ( thermal shrinkage temperature ( ° C . ) - 60 ) + b \qquad ( 1 )$$

a: corresponding to a slope of Relational Expression (1), a value of 3.25 or more and 4 or less
b: corresponding to a constant of Relational Expression (1), a value of 0 or more and 5 or less

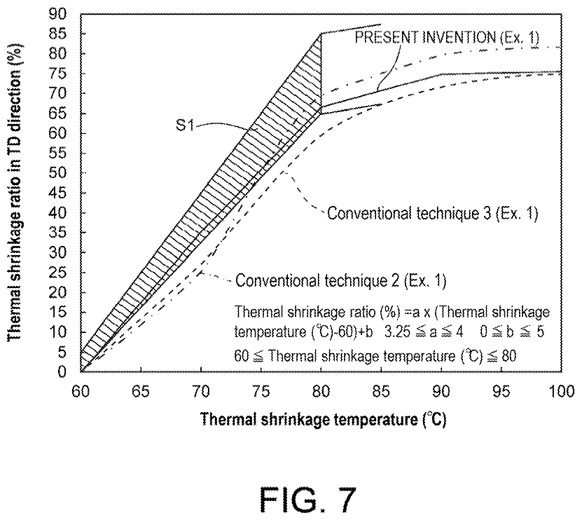

More specifically, with reference to FIG. 7, the relationship with the thermal shrinkage ratio in the main shrinkage direction (TD direction) under thermal shrinkage conditions of 60° C. to 80° C. and for 10 seconds, will be described in relation to Relational Expression (1).

That is, in FIG. 7, the horizontal axis represents the thermal shrinkage temperature (° C.), and the vertical axis represents the thermal shrinkage ratio (%) of the heat-shrinkable polyester film in the main shrinkage direction (TD direction).

It can be understood that, in FIG. 7, a shaded area (S1) interposed between two straight lines positioned in the vertical direction is within a range defined by Relational Expression (1) of the present invention and is at least within a range of 60° C. to 80° C., the thermal shrinkage ratio increases linearly as the thermal shrinkage temperature increases.

Therefore, it can be said that, even when the thermal shrinkage temperature varies and a desired thermal shrinkage ratio cannot be obtained temporarily, by controlling the clumping fraction according to Relational Expression (1) or the like to be described below, the thermal shrinkage ratio (%) of the heat-shrinkable polyester film can be controlled to be a value in a desired range.

For example, when the thermal shrinkage ratio at 60° C., 70° C., and 80° C. in the present invention is controlled to be within a predetermined range, it is very effective to use Relational Expression (1) or the like.

Here, in FIG. 7, the thermal shrinkage ratio (%) of the heat-shrinkable polyester film of conventional techniques (Patent Documents 2 and 3) is shown by curves attached to Conventional Technique 2 (Ex. 1) and Conventional Technique 3 (Ex. 1).

In the case of these curves of D2 and D3, it was found that the thermal shrinkage ratio does not decrease linearly as the thermal shrinkage temperature decreases, and a so-called S-shaped curve is formed as a whole. Moreover, it can be understood that, at around 70° C., Conventional Technique 2 (Ex. 1) and Conventional Technique 3 (Ex. 1) deviate greatly from the range defined by Relational Expression (1) of the present invention.

In addition, more preferably, as the property (D5′), the thermal shrinkage temperature and the thermal shrinkage ratio satisfy predetermined Relational Expression (2), and still more preferably, as the property (D5″), predetermined Relational Expression (3) is satisfied.

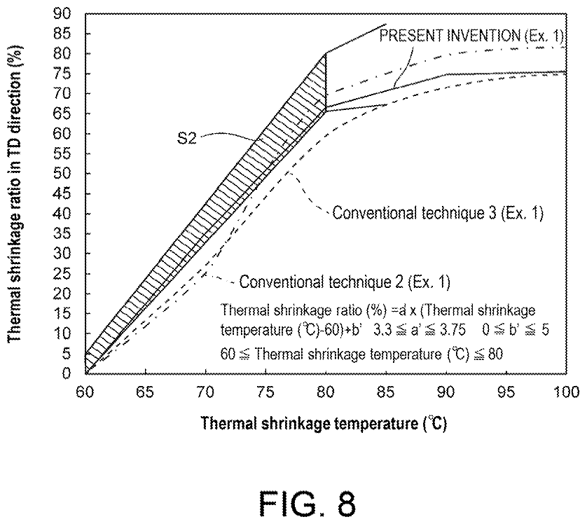

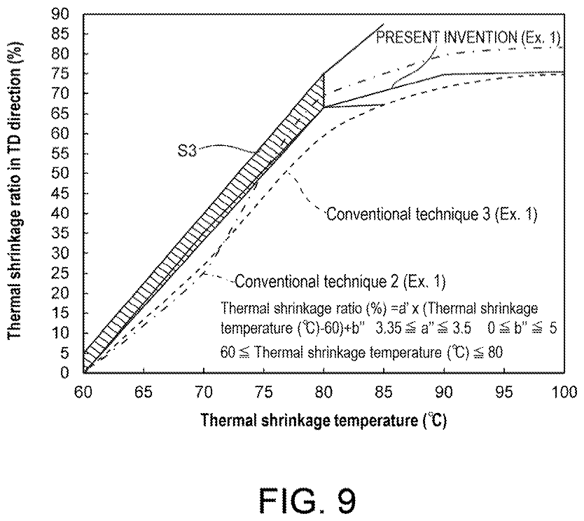

That is, in FIG. 8 and FIG. 9, shaded areas (S2 and S3) interposed between two straight lines positioned in the vertical direction are within ranges defined by Relational Expression (2) and Relational Expression (3) of the present invention. Therefore, it can be understood that, when the range is at least 60° C. to 80° C., the thermal shrinkage ratio increases linearly with higher accuracy as the thermal shrinkage temperature increases.

Here, like FIG. 7, in FIG. 8 and FIG. 9, the thermal shrinkage ratio (%) of the heat-shrinkable polyester film of conventional technique (Patent Documents 2 and 3) is shown by curves attached to Conventional Technique 2 (Ex. 1) and Conventional Technique 3 (Ex. 1).

$$[ Math . 6 ]$$

$$Thermal shrinkage ratio ( \% ) = {a}^{′} \times ( thermal shrinkage temperature ( ° C . ) - 60 ) + {b}^{′} \qquad ( 2 )$$

a′: corresponding to a slope of Relational Expression (2), a value of 3.3 or more and 3.75 or less
b′: corresponding to a constant of Relational Expression (2), a value of 0 or more and 5 or less

$$[ Math . 3 ]$$

$$Thermal shrinkage ratio ( \% ) = {a}^{′′} \times ( thermal shrinkage temperature ( ° C . ) - 60 ) + {b}^{′′} \qquad ( 3 )$$

a″: corresponding to a slope of Relational Expression (3), a value of 3.35 or more and 3.5 or less
b″: corresponding to a constant of Relational Expression (3), a value of 0 or more and 5 or less

### (6) Thermal Shrinkage Ratio D6 in MD Direction Under Predetermined Measurement Conditions

As the property (D6) of the heat-shrinkable polyester film, the thermal shrinkage ratio in the direction (MD direction) perpendicular to the main shrinkage direction measured under thermal shrinkage conditions of 70° C. and for 10 seconds is preferably a value in a range of −3 to 5%.

The reason for this is that, if the thermal shrinkage ratio in the MD direction under predetermined temperature conditions is limited in this manner, even if the periphery of the PET bottle is covered and the PET bottle is thermally shrunk at a relatively low temperature, the occurrence of spots, wrinkles, and the like is further reduced.

Therefore, even with energy-saving heating, it is easy to obtain favorable attachment, appearance, and the like.

In addition, when the thermal shrinkage ratio in the MD direction is limited in this manner, the thermal shrinkability of the entire heat-shrinkable polyester film is balanced, and even if the film is recycled together with PET bottles, it is possible to stably obtain pellets by controlling the stickiness, fluidity, and the like.

Therefore, as the property (D6), the thermal shrinkage ratio in the MD direction is more preferably a value in a range of −2.5 to 4% and still more preferably a value in a range of −2 to 3.5%.

### (7) Thermal Shrinkage Ratio D7 in MD Direction Under Predetermined Measurement Conditions

As a property (D7) of the heat-shrinkable polyester film, the thermal shrinkage ratio in the direction (MD direction) perpendicular to the main shrinkage direction measured under thermal shrinkage conditions of 60° C. to 90° C. and for 10 seconds has at least one minimum value, and the minimum value is preferably a value of −3% or more.

The reason for this is that, when the profile of the thermal shrinkage ratio in the MD direction under predetermined temperature conditions is limited to have a minimum value with a predetermined magnitude, even if temperature conditions vary slightly and the thermal shrinkage ratio changes, favorable appearance, accurate information, and the like are easy to be obtained when correcting the variation and thermal shrinkage can be more clearly determined by actual measurement of a simple thermal shrinkage curve, TMA measurement or the like.

Moreover, when the thermal shrinkage ratio in the MD direction in a predetermined temperature range is limited, the thermal shrinkability of the entire heat-shrinkable polyester film can be balanced, the generated thermal shrinkage stress can be reduced and it is possible to obtain pellets more stably even if the film is recycled together with PET bottles.

Therefore, as the property (D7), the minimum value of the thermal shrinkage ratio in the MD direction is more preferably a value in a range of −1 to 2% and still more preferably a value in a range of −0.5 to 1%.

### (8) Thermal Shrinkage Ratio D8 in MD Direction Under Predetermined Measurement Conditions

As a property (D8) of the heat-shrinkable polyester film, the thermal shrinkage ratio in the direction (MD direction) perpendicular to the main shrinkage direction measured under thermal shrinkage conditions of 60° C. to 90° C. and for 10 seconds has at least one maximum value, and the maximum value is preferably a value of 3% or less.

The reason for this is that, when the profile of the thermal shrinkage ratio in the MD direction under predetermined temperature conditions is limited in this manner to have a maximum value with a predetermined magnitude, during thermal shrinkage, the fact that favorable appearance, accurate information, and the like are likely to be obtained and the generated thermal shrinkage stress is a predetermined value or less, can be more clearly determined.

Here, when the profile of the thermal shrinkage ratio has a maximum value with a predetermined magnitude, additionally, it is preferable to have the above minimum value with a predetermined magnitude at the same time.

Therefore, as the property (D8), the maximum value of the thermal shrinkage ratio in the MD direction is more preferably a value in a range of −1 to 2% and still more preferably a value in a range of −0.5 to 1.5%.

### 6. Thickness

Here, the thickness (average thickness, hereinafter the same) of the heat-shrinkable polyester film can be changed according to the shape of various PET bottles, and generally, it is preferably a value in a range of 10 to 100 μm.

The reason for this is that, when the thickness of the heat-shrinkable polyester film is a value of less than 10 μm, it becomes difficult to handle, and the breaking strength and the like may significantly decrease.

On the other hand, when the thickness of the heat-shrinkable polyester film is more than 100 μm, when the film is heated at a predetermined temperature, it may not be uniformly and thermally shrunk, or it may be difficult to produce a film with a uniform thickness.

Therefore, the thickness of the heat-shrinkable polyester film is more preferably a value in a range of 20 to 70 μm and still more preferably a value in a range of 40 to 60 μm.

Here, the thickness of the heat-shrinkable polyester film can be measured and calculated using a micrometer (product name “Thickness Gauge 547-401,” commercially available from Mitutoyo Corporation) according to ISO4593.

Here, as described above with reference to FIG. 2B, the standard deviation as the variation of the average thickness of the heat-shrinkable polyester film measured under predetermined conditions is preferably a value of 1.7 μm or less.

The reason for this is that, when the standard deviation of the average thickness is set to a predetermined value or less, even in the case of the heat-shrinkable polyester film derived from a crystalline polyester resin serving as a main component (for example, 80 wt % or more), the balance between recyclability and thermal shrinkability is further improved.

However, when the standard deviation of the average thickness becomes excessively small, the yield significantly decreases, which will be economically disadvantageous, or the types of mixing components used in the polyester resin may be excessively limited.

Therefore, the standard deviation of the average thickness of the heat-shrinkable polyester film is more preferably a value in a range of 0.05 to 1.4 μm and still more preferably a value in a range of 0.1 to 1.2 μm.

Here, a method of measuring the standard deviation of the average thickness will be described in detail in Example 1.

### 7. Functional Layer

As long as the objective and the like of the present invention are not impaired, the heat-shrinkable polyester film preferably has functional layers for imparting various functions as necessary.

Examples of such functional layers include a coating layer for imparting surface lubricity, stain resistance, weather resistance, and the like, a transfer layer, and a printing layer for imparting design properties.

Here, among these, a coating layer using a surfactant is particularly preferable as a functional layer because it greatly contributes to improvement of antistatic properties and surface lubricity.

For example, as shown in FIG. 1B, it is also preferable to laminate other resin layers 10a and 10b containing at least one of these various additives on one surface or both surfaces of a heat-shrinkable polyester film 10.

In this case, when the thickness of the heat-shrinkable polyester film is 100%, the single-layer thickness or the total thickness of other resin layers to be additionally laminated is generally preferably a value in a range of 0.1 to 10%.

Here, the resin that is the main component constituting the other resin layers may be a polyester resin similar to the heat-shrinkable polyester film, or is preferably at least one different acrylic resin, olefin resin, urethane resin, rubber material, or the like.

In addition, the heat-shrinkable polyester film has a multi-layer structure so that the hydrolysis prevention effect and mechanical protection are further improved, or as shown in FIG. 1C, it is also preferable to provide a shrinkage rate adjusting layer 10c on the surface of the heat-shrinkable polyester film 10 so that the shrinkage rate of the heat-shrinkable polyester film becomes uniform in the plane.

The shrinkage rate adjusting layer can be laminated as a predetermined layer made of a polyester resin or the like using an adhesive, a coating method, a heat treatment, or the like according to the shrinkage of the heat-shrinkable polyester film.

### 8. Haze Value and Haze Value/Thickness

### (1) Haze Value

Here, the haze value of the heat-shrinkable polyester film measured according to ASTM D1003 is preferably a value in a range of 2 to 8%.

The reason for this is that, when the haze value is more than 8%, this is not preferable because there is a risk that transparency may be poor and the appearance may deteriorate during label production.

Therefore, the haze value is more preferably 7% or less and still more preferably 6% or less.

Here, the haze value can be measured using a haze meter or the like, and generally, the transparency is higher as the value is preferably smaller, but considering that a predetermined amount of a lubricant should be added to the film in order to impart practically necessary slipperiness, the lower limit is about 2%.

### (2) Haze Value/Thickness

Here, the haze value/thickness of the heat-shrinkable polyester film is preferably a value of 0.15%/μm or less.

The reason for this is that, when the haze value/thickness is more than 0.15%/μm, a good balance between recyclability and thermal shrinkability may deteriorate.

Therefore, the haze value/thickness is more preferably a value of 0.14%/μm or less and still more preferably a value of 0.13%/μm or less.

However, when the haze value/thickness becomes excessively small, production management of the heat-shrinkable polyester film, restrictions on the mixing materials and the like may become excessively strict.

Therefore, the haze value/thickness is preferably a value of 0.03%/μm or more, more preferably a value of 0.04%/μm or more, and still more preferably a value of 0.05%/μm or more.

### Second Embodiment

The second embodiment is a method of producing the heat-shrinkable polyester film of the first embodiment. Hereinafter, the method will be described in detail by dividing it into respective processes.

### 1. Raw Material Preparation and Mixing Process

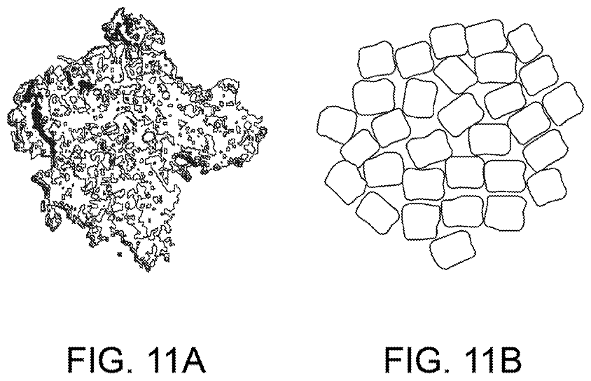

As raw materials, main agents and additives such as recycled crystalline polyester resin pellets, rubber resins, antistatic agents, and hydrolysis prevention agents as shown in FIG. 11B are prepared.

When such raw materials are prepared, it is preferable that recycled crystalline polyester resin pellets serving as a main component are heated at a predetermined temperature (for example, at a temperature lower than 10° C. from the crystallization temperature) for a predetermined time (for example, for 3 to 10 hours) to be absolutely dried.

Next, it is preferable to put recycled crystalline polyester resin pellets and the like into a stirring container while weighing them, and mix and stir the recycled crystalline polyester resin pellets and the like using a stirring device until the mixture becomes uniform.

Here, as the crystalline polyester resin, non-recycled crystalline polyester resin pellets may be used in addition to the recycled crystalline polyester resin pellets.

That is, economically, as the crystalline polyester resin, it is preferable to use a relatively large amount of recycled crystalline polyester resin pellets, for example, 50 wt % or more, with respect to the total amount.

On the other hand, in order to easily adjust the clumping fraction, the melting point, the melting heat quantity, the haze value, and the like to be within desired ranges, it is preferable to use a relatively large amount of non-recycled crystalline polyester resin pellet, for example, 50 wt % or more, with respect to the total amount.

### 2. Process of Producing Raw Sheet

Next, typically, it is preferable to perform extrusion molding (T-die method), an inflation method, or a cast molding method to produce a raw sheet having a predetermined thickness.

More specifically, for example, extrusion molding is performed using an extruder under conditions of an extrusion temperature of 245° C., and thereby a raw sheet having a predetermined thickness (generally, 200 to 300 μm) can be obtained.

### 3. Production of Heat-Shrinkable Polyester Film

Next, the obtained raw sheet is heated and pressed while being moved on or between rollers using a heat-shrinkable film producing device (tenter) to produce a heat-shrinkable polyester film.

However, as a stretching treatment method for exhibiting such shrinkage, an inflation method, a roll stretching method, a tenter stretching method, and a combination thereof are known.

Here, since the productivity is better, it is more preferable to combine sheet molding according to a cast molding method, roll stretching, and tenter stretching.

That is, while preheating at a predetermined preheating temperature, for example, in a temperature range of 110° C. to 150° C., while the width of the film is basically expanded at a predetermined stretching temperature, a maximum stretching rate, and a stretching magnification, and while heating and pressing, stretching is performed in a predetermined direction, and thus it is preferable to crystallize the molecules of the polyester resin constituting the heat-shrinkable polyester film in a predetermined state.

Here, at a predetermined heat fixing temperature, for example, at a temperature in a range of 60° C. to 80° C., the film is solidified in that state, and thus it is possible to produce a thermally shrinkable heat-shrinkable polyester film used as a decoration, a label, or the like.

That is, generally, after a raw film is produced by a T-die method, an inflation method, or the like, the raw film is heated to a temperature equal to or higher than the glass transition temperature of the resin, and it is preferable to perform stretching at a maximum stretching rate of a value in a range of 40 to 67%/sec., and preferably a value in a range of 45 to 62%/sec., and in a magnification range of 3 to 8, and preferably a magnification range of 4 to 6 at least in the main stretching direction (the width direction of the raw film, that is, the TD direction).

### 4. Effect of Maximum Stretching Rate

(1) Relationship with Standard Deviation of Predetermined Thermal Shrinkage Ratio

As shown by the property curve L1 in FIG. 2A described above, assuming a predetermined clumping fraction, it was found that there is a predetermined correlation between the maximum stretching rate and the standard deviation of the thermal shrinkage ratio in the main shrinkage direction at 100° C. for 10 seconds.

Here, as shown by the property curve L1′ in FIG. 2B, it was found that, regardless of whether there is a predetermined clumping fraction, there is a predetermined correlation between the maximum stretching rate and the standard deviation of the thickness. Here, it can be understood that, from the property curve L1′, when the maximum stretching rate falls below 40%/sec., the standard deviation of the thickness is at least a value of more than 1.7 μm.

(2) Relationship with Crystallization Heat Quantity

Here, as shown by the property curve L3 in FIG. 4, it was found that there is a predetermined correlation between the maximum stretching rate and the crystallization heat quantity in the obtained heat-shrinkable polyester film.

That is, under certain requirements, when the maximum stretching rate value is set to be within a predetermined range, the value of the crystallization heat quantity in the obtained heat-shrinkable polyester film can be stably controlled to be a desired range value.

For example, when the maximum stretching rate is controlled to be within a range of 40 to 65%/sec., the value of the crystallization heat quantity in the obtained heat-shrinkable polyester film can be controlled to be within a range of 12 to 15 mJ/mg.

(3) Relationship with Glass Transition Temperature

Here, as shown by the property curve L4 in FIG. 5, it was found that there is a predetermined correlation between the maximum stretching rate and the glass transition temperature in the obtained heat-shrinkable polyester film.

That is, under certain requirements, when the maximum stretching rate value is set to be within a predetermined range, the value of the glass transition temperature in the obtained heat-shrinkable polyester film can be stably controlled to be a desired range value.

For example, when the maximum stretching rate is controlled to be within a range of 40 to 58%/sec. or less, the value of the glass transition temperature in the obtained heat-shrinkable polyester film can be controlled to be around 74.5° C.

Here, for example, there is a tendency that, when the maximum stretching rate passes 58%/sec. and reaches in a range of about 65%/sec., the value of the glass transition temperature in the obtained heat-shrinkable polyester film to decrease from around 74.5° C. to around 74.3° C. is observed.

In addition, for example, it can be understood that, when the maximum stretching rate is in a range more than 65%/sec., the value of the glass transition temperature in the obtained heat-shrinkable polyester film certainly decreases to 74.3° C. or lower, and this tends to continue.

(4) Relationship with Melting Heat Quantity (ΔHm)

Here, as shown by the property curve L5 in FIG. 6, it was found that there is a predetermined correlation (linear relationship) between the maximum stretching rate and the melting heat quantity (ΔHm) in the obtained heat-shrinkable polyester film.

That is, under certain requirements, for example, when the maximum stretching rate value is set to be within a range of 40 to 65%/sec., the crystallization temperature and the melting heat quantity in the obtained heat-shrinkable polyester film can be stably controlled to desired values using a linear relationship.

On the other hand, it can be understood that, for example, when the maximum stretching rate value is more than 65%/sec., since the correlation (linear relationship) decreases, it becomes difficult to control the melting heat quantity to a desired value.

### 5. Process of Examining Heat-Shrinkable Polyester Film

It is preferable to continuously or intermittently measure the following properties and the like of the produced heat-shrinkable polyester film and provide a predetermined examination process.

That is, a heat-shrinkable polyester film having more uniform shrinkage and the like can be obtained by measuring the following properties and the like according to the predetermined examination process, and confirming that the values are within predetermined ranges.
1) Visual examination of appearance of heat-shrinkable polyester film
2) Thickness variation measurement
3) Tensile strength measurement (ASTM D882)
4) Tensile elongation measurement (ASTM D882)
5) Surface slipperiness examination (ASTM D1894)
6) Specific gravity measurement (ASTM D792)
7) Ring crush test (TAPPI T882)
8) Tear strength measurement (ASTM D1922)

### EXAMPLES

Hereinafter, the present invention will be described in detail with reference to examples. However, absent any particular reason, the scope of rights of the present invention is not limited by the description of examples.

Here, the crystalline polyester resin, the amorphous polyester resin, and the like used in Example 1 and the like are as follows.

Here, the intrinsic viscosity (IV value) described in the column of the amorphous polyester resin in a mixed solvent of phenol/1, 1,2,2-tetrachloroethane (weight ratio=1/1) was measured at a temperature of 30° C. using an Ubbelohde viscometer.

### (PET1)

As the crystalline polyester resin, PET1 (commercially available from Eastman Chemical Company, product name “Embrace Encore,” glass transition temperature (Tg): 74° C., melting point: 217° C., density: 1.3 g/cm³) was prepared.

### (PET2)

As the crystalline polyester resin, PET2 (crystalline polyester resin composed of dicarboxylic acid: terephthalic acid 98.6 mol %, isophthalic acid 1.4 mol %, diol: ethylene glycol 97.3 mol %, diethylene glycol 2.7 mol % (glass transition temperature (Tg): 78° C., melting point: 251° C., intrinsic viscosity (IV value): 0.72, density: 1.3 g/cm³)) was prepared as a crystalline polyester resin different from PET1. That is, after recycling the commercially available PET bottle, a crystalline polyester resin was obtained by pelletizing as shown in FIG. 11B.

Here, PET2 was used only in Evaluation 1 (clumping fraction) in examples to be described below.

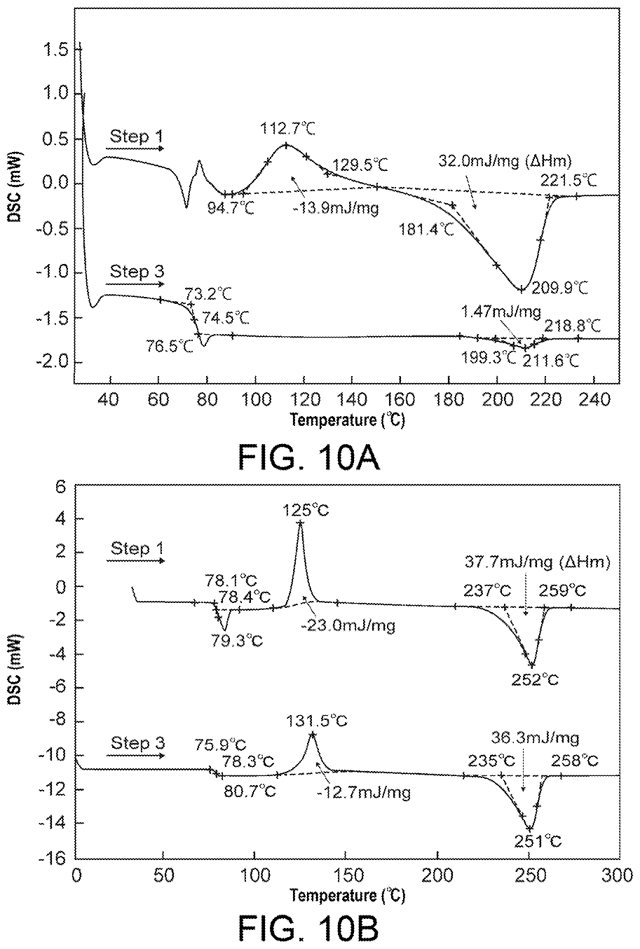

Here, FIG. 10B shows an example of a DSC chart of PET2 obtained by DSC measurement according to JIS K 7121:2012.

That is, in Step 1, a measurement sample was heated using a DSC device at a temperature increasing rate of 10° C./min from 30° C. to 300° C.

Next, in Step 2, the temperature was rapidly temporarily lowered at a temperature decreasing rate of 100° C./min from 300° C. to 0° C. (not shown in FIG. 10B).

In addition, in Step 3, the temperature was raised at a temperature increasing rate of 10° C./min from 0° C. to 300° C.

Here, based on the temperature of the specific heat change point of the DSC curve obtained in Step 1 and Step 3, the temperature of the expressed peak point and the like, the glass transition temperature, the melting peak, and the like which define properties of PET2, could be determined accurately.

### (PETG)

As the amorphous polyester resin, PETG (amorphous polyester composed of dicarboxylic acid: terephthalic acid 100 mol %, diol: ethylene glycol, 1,4-cyclohexanedimethanol, and diethylene glycol (commercially available from Eastman Chemical Company, product name “Embrace LV,” glass transition temperature (Tg): 68.2° C., no melting point, intrinsic viscosity (IV value): 0.7, density: 1.3 g/cm³)) was prepared.

### (Additive)

As an additive (antiblocking agent), a silica masterbatch was prepared by mixing 20 parts by mass of silica with 80 parts by mass of a polyethylene terephthalate resin (commercially available from Sukano, product name “G dc S559-E”, product containing 20 wt % of Silica).

### Example 1

### 1. Production of Heat-Shrinkable Polyester Film

As a crystalline polyester resin, the above PET1 was prepared.

Next, 1000 g of the prepared PET1 was put into a stirring container.

Here, as an anti-blocking agent for the heat-shrinkable film, the above Anti-Blocking Agent dried under predetermined conditions was mixed at a proportion of 1 part by weight based on 100 parts by weight of PET1 to obtain a raw material for forming a heat-shrinkable film.

Next, the raw material for forming this heat-shrinkable film was subjected to extrusion molding with an extruder under conditions of an extrusion temperature of 245° C. using a vent type twin-screw extruder to obtain a raw sheet having a thickness of 250 μm.

Finally, using a heat-shrinkable film producing device, a heat-shrinkable polyester film having a set thickness of 50 μm was produced from the raw sheet at a preheating temperature of 125° C., a maximum stretching rate of 56%/sec., a stretching temperature of 86° C., a heat fixing temperature of 72° C., and a stretching magnification (MD direction: 1.07 times, TD direction: 4.8 times).

### 2. Evaluation of Heat-Shrinkable Polyester Film

### (1) Evaluation 1 (Clumping Fraction)

As shown in Table 1, PET1, PET2, and PETG were appropriately mixed to obtain a polyester resin.

Next, according to APR Document Code: PET-S-08, the clumping fraction of the polyester resin (the crystalline polyester resin, the amorphous polyester resin, or a mixture thereof) was measured, and evaluated based on the following criteria.
⊙ (Very good): the clumping fraction was 1% or less.
◯ (Good): the clumping fraction was 1.2% or less.
Δ (Fair): the clumping fraction was 1.4% or less.
X (Bad): the clumping fraction was more than 1.4%.

### (2) Evaluation 2 (DSC Measurement of Heat-Shrinkable Polyester Film)

The melting point (melting peak temperature) and the like of the obtained heat-shrinkable polyester film were measured using a DSC device (product name “DSC7000X” commercially available from Hitachi High-Tech Science Corporation) under predetermined conditions.

More specifically, a sample of the heat-shrinkable polyester film was dried in a dry oven at 60° C. for 6 hours or longer.

Next, the sample was set in a differential scanning calorimeter, and temporarily heated to a high temperature range in Step 1 (the temperature was raised at a temperature increasing rate of 10° C./min from 25° C. to 250° C.).

Next, in Step 2 (the temperature was lowered at a temperature decreasing rate of 10° C./min from 250° C. to 25° C.), the temperature was temporarily lowered to a low temperature range. Finally, in Step 3 (the temperature was raised at a temperature increasing rate of 10° C./min, from 25° C. to 250° C.), the temperature was raised again to a high temperature range.

Here, as shown in FIG. 10A, from the obtained DSC curve, the glass transition temperature, the crystallization temperature, the crystallization heat quantity, the melting point (melting peak temperature), and the melting heat quantity (ΔHm) corresponding to the melting peak area were measured.

### (3) Evaluation 3 (Thermal Shrinkage Ratio)

The thermal shrinkage ratio of the obtained heat-shrinkable polyester film was measured according to ASTM D2732-08.

That is, the film was cut into a square shape with a length of 100 mm in the main shrinkage direction (TD direction) and a length of 100 mm in the non-shrinkage direction (MD direction) and used as a measurement sample.

Next, the obtained heat-shrinkable polyester film was immersed in a thermostatic tank containing warm water whose temperature was controlled to 60° C., 70° C., 80° C., 90° C., and 100° C. in increments of 10° C. for 10 seconds and thermally shrunk.

Next, at each temperature, from the dimensional changes before and after the heat treatment, according to the following formula (5), each of the thermal shrinkage ratios (%) in the main shrinkage direction (TD direction) and the non-shrinkage direction (MD direction) were calculated.

$$[ Math . 8 ]$$

$$Thermal shrinkage ratio ( \% ) = \frac{100 mm - Length of film after thermal shrinkage}{100 mm} \times 100 \qquad ( 5 )$$

### (4) Evaluation 4 (Standard Deviation of Thermal Shrinkage Ratio)

The thermal shrinkage ratio of the obtained heat-shrinkable polyester film was measured according to ASTM D2732-08 in the following procedure, and the standard deviation was calculated.

First, for the obtained heat-shrinkable polyester film, eight measurement samples were obtained evenly in the width direction.

That is, the film was cut into a square shape with a length of 100 mm in the main shrinkage direction (TD direction) and a length of 100 mm in the non-shrinkage direction (MD direction) and eight samples were prepared as measurement samples.

Next, as a pretreatment, the prepared eight measurement samples were left in an atmosphere of 23° C. and 50% RH for 40 hours or longer.

Next, each of the eight pretreated measurement samples was immersed in a thermostatic tank containing warm water whose temperature was controlled to 100° C. for 10 seconds and thermally shrunk.

Next, from the dimensional changes before and after the heat treatment, according to the above formula (5), each of the thermal shrinkage ratios (%) in the main shrinkage direction (TD direction) were calculated.

Next, a standard deviation was additionally calculated from the calculated thermal shrinkage ratio of the eight measurement samples, and evaluated based on the following criteria.
⊙ (Very good): The standard deviation of the thermal shrinkage ratio was 1.0% or less.
◯ (Good): The standard deviation of the thermal shrinkage ratio was 1.5% or less.
Δ (Fair): The standard deviation of the thermal shrinkage ratio was 2.5% or less.
X (Bad): The standard deviation of the thermal shrinkage ratio was more than 2.5%.

### (5) Evaluations 5 and 6 (Thickness and Standard Deviation)

The thickness of the obtained heat-shrinkable polyester film was measured at 20 points on the film in the width direction at equal intervals using a micrometer (product name “Thickness Gauge 547-401,” commercially available from Mitutoyo Corporation) according to ISO4593, and the average value thereof was calculated and used as the thickness (average thickness).

Here, the standard deviation was additionally calculated from the measured values at 20 points used for calculating the thickness (average thickness) of the obtained heat-shrinkable polyester film and evaluated based on the following criteria.
⊙ (Very good): The standard deviation of the thickness was 1.4 μm or less.
◯ (Good): The standard deviation of the thickness was 1.7 μm or less.
Δ (Fair): The standard deviation of the thickness was 2 μm or less.
X (Bad): The standard deviation of the thickness was more than 2 μm.

### (6) Evaluation 7 (Haze Value)

The haze value of the obtained heat-shrinkable polyester film was measured using a haze meter (product name “haze-gard dual,” commercially available from BYK) according to ASTM D1003 and evaluated based on the following criteria.
⊙ (Very good): The haze value was 7% or less.
◯ (Good): The haze value was 8% or less.
Δ (Fair): The haze value was 10% or less.
X (Bad): The haze value was more than 10%.

### (7) Evaluation 8 (Attachment/Appearance)

An eggplant-shaped PET bottle (product name “Limmi Lemon Juice,” volume: 200 ml) filled with commercially available drinking water was prepared.

Next, 1,3-dioxolane was applied to ends of a long sample in the width direction obtained by cutting the heat-shrinkable polyester film to a width of 20.5 cm.

Next, the ends in the width direction were overlapped and adhered to each other so that the overlapping margin was about 1 cm to obtain a cylindrical label having a diameter of about 6.2 cm. In addition, this cylindrical label was cut out in the longitudinal direction every 11 cm to obtain a plurality of cylindrical labels.

Next, the cylindrical label was placed on the body of a prepared substantially columnar PET bottle, and placed on a belt conveyor in a steam tunnel maintained at 80° C., and moved while being heated for 8 seconds, and thermal shrinkage was performed so that the cylindrical label was in close contact with the body of the substantially columnar PET bottle from the top to the bottom.

Next, it was visually observed whether poor attachment in which the cylindrical label after thermal shrinkage was not in close contact with the PET bottle under conditions of a predetermined length (5 mm or more) and a predetermined width (1 mm or more) occurred or whether spots and wrinkles occurred, and the attachment was evaluated based on the following criteria.
⊙ (Very good): Poor attachment, spots, and wrinkles were not observed in any of the five cylindrical labels.
◯ (Good): Poor attachment, spots, and wrinkles were not observed in three or more out of the five cylindrical labels.
Δ (Fair): Poor attachment, spots, and wrinkles were not observed in one or more out of the five cylindrical labels.
X (Bad): Poor attachment, spots, and wrinkles were observed in all of the five cylindrical labels.

### Example 2

In Example 2, as shown in Table 1, a heat-shrinkable polyester film was produced and evaluated in the same manner as in Example 1 except that the preliminary heating temperature (° C.), the maximum stretching rate (%/sec.), and the like were changed. The obtained results are shown in Table 2.

### Example 3

In Example 3, a heat-shrinkable polyester film was produced and evaluated in the same manner as in Example 1 except that the set thickness of the heat-shrinkable polyester film was 45 μm, and as shown in Table 1, the maximum stretching rate (%/sec.) and the like were changed. The obtained results are shown in Table 2.

### Examples 4 and 5

In Examples 4 and 5, as shown in Table 1, heat-shrinkable polyester films were produced and evaluated in the same manner as in Example 1 except that the stretching temperature (° C.), the heat fixing temperature (° C.), the maximum stretching rate (%/sec.), and the like were changed. The obtained results are shown in Table 2.

### Example 6

In Example 6, as shown in Table 1, a heat-shrinkable polyester film was produced and evaluated in the same manner as in Example 1 except that, as the PET resin, the above PET1 and PETG (mixing ratio=80/20) were used. The obtained results are shown in Table 2.

### Comparative Example 1

In Comparative Example 1, as shown in Table 1, a heat-shrinkable polyester film was produced and evaluated in the same manner as in Example 1 except that the preliminary heating temperature (° C.), the stretching temperature (° C.), the maximum stretching rate (%/sec.), and the like were changed. The obtained results are shown in Table 2.

### Comparative Example 2

In Comparative Example 2, as shown in Table 1, a heat-shrinkable polyester film was produced and evaluated in the same manner as in Example 1 except that the preliminary heating temperature (° C.), the stretching temperature (° C.), the heat fixing temperature (° C.), the maximum stretching rate (%/sec.), and the like were changed by using the above PET1 and PETG (mixing ratio=80/20) as the PET resin. The obtained results are shown in Table 2.

### Comparative Example 3

In Comparative Example 3, as shown in Table 1, a heat-shrinkable polyester film was produced and evaluated in the same manner as in Example 1 except that the preliminary heating temperature (° C.), the stretching temperature (° C.), the heat fixing temperature (° C.), the maximum stretching rate (%/sec.), and the like were changed by using the above PET1 and PETG (mixing ratio=60/40) as the PET resin. The obtained results are shown in Table 2.

TABLE 1

| | | | | | | | Stretching | Stretching | | |
|---|---|---|---|---|---|---|---|---|---|---|
| | | | | Preliminary | | | magnification | magnification | Maximum | |
| | PET1 | PETG1 | Additive | heating | Stretching | Heat fixing | in MD | in TD | stretching | Average |
| | (parts by | (parts by | (parts by | temperature | temperature | temperature | direction | direction | rate | thickness |
| | weight) | weight) | weight) | (° C.) | (° C.) | (° C.) | (%) | (%) | (%/sec.) | (μm) |
| Example 1 | 100 | | 1 | 125 | 86 | 72 | 107 | 480 | 56 | 50.3 |
| Example 2 | 100 | | 1 | 130 | 86 | 72 | 107 | 480 | 62 | 49.3 |
| Example 3 | 100 | | 1 | 125 | 86 | 72 | 107 | 480 | 64 | 44.7 |
| Example 4 | 100 | | 1 | 125 | 89 | 76 | 107 | 480 | 44 | 50.7 |
| Example 5 | 100 | | 1 | 125 | 88 | 72 | 107 | 480 | 51 | 49.2 |
| Example 6 | 80 | 20 | 1 | 125 | 86 | 72 | 107 | 480 | 56 | 50.3 |
| Comparative | 100 | | 1 | 130 | 89 | 72 | 107 | 480 | 70 | 49.8 |
| Example 1 | | | | | | | | | | |
| Comparative | 80 | 20 | 1 | 120 | 89 | 80 | 107 | 480 | 51 | 50.2 |
| Example 2 | | | | | | | | | | |
| Comparative | 60 | 40 | 1 | 120 | 89 | 80 | 107 | 480 | 51 | 49.7 |
| Example 3 | | | | | | | | | | |

TABLE 2

| | Thermal shrinkage ratio | | | | | Standard | | | |
|---|---|---|---|---|---|---|---|---|---|
| | (%) at each temperature | | | | | deviation | Standard | | |
| | (upper: MD direction, | | | | | of thermal | deviation | Glass | |
| | lower: TD direction) | | | | | shrinkage | of | transition | Crystallization |
| | 60° | 70° | 80° | 90° | 100° | ratio | thickness | temperature | temperature |
| | C. | C. | C. | C. | C. | (%) | (μm) | (° C.) | (° C.) |
| Example 1 | 0.0 | 0.5 | 0.0 | 4.8 | 6.4 | 0.6 | 1.1 | 74.5 | 112.7 |
| | 0.0 | 34.9 | 66.8 | 74.6 | 75.9 | | | | |
| Example 2 | 0.0 | −2.0 | −0.1 | 3.6 | 5.1 | 0.7 | 1.1 | 74.3 | 112.9 |
| | 0.0 | 39.0 | 67.8 | 74.3 | 75.4 | | | | |
| Example 3 | 0.0 | 1.3 | 0.0 | 5.0 | 6.8 | 0.9 | 0.7 | 74.5 | 113.5 |
| | 0.0 | 33.0 | 67.5 | 75.0 | 76.0 | | | | |
| Example 4 | 0.0 | −2.4 | −2.5 | 1.8 | 4.1 | 0.4 | 1.6 | 74.5 | 112.0 |
| | 0.0 | 37.0 | 64.4 | 73.0 | 74.9 | | | | |
| Example 5 | 0.0 | −0.3 | −0.4 | 5.5 | 6.0 | 0.5 | 1.7 | 74.5 | 110.9 |
| | 0.0 | 36.9 | 66.5 | 74.5 | 76.6 | | | | |
| Example 6 | 0.0 | −2.0 | −3.0 | 2.0 | 6.0 | 0.6 | 1.0 | 74.5 | 108.2 |
| | 0.0 | 36.0 | 63.0 | 71.0 | 71.0 | | | | |
| Comparative | 0.0 | 0.1 | −0.9 | 3.4 | 5.0 | 4.3 | 1.0 | 74.3 | 110.8 |
| Example 1 | 0.0 | 29.9 | 63.8 | 71.1 | 71.9 | | | | |
| Comparative | 0.0 | −0.4 | −0.8 | 3.6 | 5.8 | 2.6 | 1.5 | 73.1 | 105.2 |
| Example 2 | 0.0 | 28.4 | 59.0 | 67.8 | 69.8 | | | | |
| Comparative | 0.0 | 0.0 | 2.0 | 6.0 | 6.0 | 1.9 | 1.4 | 71.8 | 108.4 |
| Example 3 | 0.0 | 31.0 | 60.0 | 72.0 | 74.0 | | | | |

| | | Melting peak | Melting | | | | | | |
|---|---|---|---|---|---|---|---|---|---|
| | Crystallization | temperature | heat | Haze | | | | | |
| | heat quantity | (melting point) | quantity | value | Eva | Eva | Eva | Eva | Eva |
| | (mJ/mg) | (° C.) | (mJ/mg) | (%) | 1 | 4 | 6 | 7 | 8 |
| Example 1 | 13.9 | 209.9 | 32.0 | 3.9 | ⊙ | ⊙ | ⊙ | ⊙ | ⊙ |
| Example 2 | 14.4 | 210.5 | 31.6 | 3.5 | ⊙ | ⊙ | ⊙ | ⊙ | ⊙ |
| Example 3 | 18.6 | 210.3 | 31.6 | 4.7 | ⊙ | ⊙ | ⊙ | ⊙ | ⊙ |
| Example 4 | 13.2 | 209.3 | 34.1 | 2.7 | ⊙ | ⊙ | ◯ | ⊙ | ◯ |
| Example 5 | 12.5 | 209.5 | 33.0 | 3.9 | ⊙ | ⊙ | ◯ | ⊙ | ◯ |
| Example 6 | 10.5 | 209.0 | 34.5 | 4.1 | ◯ | ⊙ | ⊙ | ⊙ | ⊙ |
| Comparative | 6.8 | 209.1 | 35.1 | 4.0 | ◯ | X | ⊙ | ⊙ | X |
| Example 1 | | | | | | | | | |
| Comparative | 11.2 | 204.4 | 38.1 | 3.1 | X | X | ◯ | ⊙ | X |
| Example 2 | | | | | | | | | |
| Comparative | 9.1 | 192.4 | 27.2 | 3.5 | X | Δ | ⊙ | ⊙ | ◯ |
| Example 3 | | | | | | | | | |

Eva 1: Clumping fraction
Eva 4: Standard deviation of thermal shrinkage ratio
Eva 6: Standard deviation of thickness
Eva 7: Haze value
Eva 8: Attachment/appearance

### INDUSTRIAL APPLICABILITY

According to the present invention, when at least the predetermined properties (A) to (C) such as the clumping fraction and (D1) to (D4) relating to the thermal shrinkage ratio are controlled, a good balance between recyclability and thermal shrinkability is achieved.

That is, like the recycled PET mainly using a crystalline polyester resin, when the predetermined clumping fraction and the like are strictly controlled, even when the PET bottle to which the heat-shrinkable polyester film is attached is recycled, an interlocking phenomenon can be effectively prevented, and desired recycled pellets can be produced effectively and stably.

Here, accordingly, variations in the thermal shrinkage ratio and the thickness of the heat-shrinkable polyester film are reduced, thermal shrinkage stress or the like generated during thermal shrinkage is controlled, and it is possible to provide a heat-shrinkable polyester film that exhibits excellent attachment and appearance in a wide temperature range.

Moreover, according to the heat-shrinkable polyester film of the present invention, even if a desired thermal shrinkage ratio cannot be obtained due to slight changes in the thermal shrinkage temperature and the like regardless of the thickness, it is possible to accurately correct and control the thermal shrinkage ratio to be within a desired range.

Therefore, it can be said that excellent attachment and appearance can be exhibited for various PET bottles and the like, and not only that, the film attached to various PET bottles and the like can be recycled together, and thus versatility can be significantly extended while environmental and economic properties are maintained, and its industrial applicability is extremely high.

### EXPLANATIONS OF LETTERS OR NUMERALS

10: Heat-shrinkable polyester film
10a: Other resin layer 1
10b: Other resin layer 2
10c: Shrinkage rate adjusting layer

1. A heat-shrinkable polyester film derived from a polyester resin which is a reaction product of a polycarboxylic acid and a polyalcohol, having the following properties (A) to (C) and (D1) to (D4):
(A) a clumping fraction in a mixture of the polyester resin and other PET resins, which is measured according to APR Document Code: PET-S-08, is a value of 1.2% or less;
(B) a melting point of the polyester resin measured through DSC is a value in a range of 190° C. to 230° C.;
(C) a melting heat quantity of the heat-shrinkable polyester film corresponding to a melting peak area at a melting point measured through DSC is a value in a range of 25 to 45 mJ/mg;
(D1) a thermal shrinkage ratio in the main shrinkage direction measured under thermal shrinkage conditions of 60° C. and for 10 seconds is a value in a range of 0 to 5%;
(D2) a thermal shrinkage ratio in the main shrinkage direction measured under thermal shrinkage conditions of 70° C. and for 10 seconds is a value in a range of 25 to 50%;
(D3) a thermal shrinkage ratio in the main shrinkage direction measured under thermal shrinkage conditions of 80° C. and for 10 seconds is a value in a range of 55 to 85%; and
(D4) a standard deviation of the value of the thermal shrinkage ratio in the main shrinkage direction measured under thermal shrinkage conditions of 95° C. to 100° C. and for 10 seconds is a value of 1.5% or less.

2. The heat-shrinkable polyester film according to claim 1, having a property (D4′) in which a thermal shrinkage ratio in the main shrinkage direction measured under thermal shrinkage conditions of 95° C. to 100° C. and for 10 seconds is a value of 70% or more.

3. The heat-shrinkable polyester film according to claim 1, having a property (D5) in which a thermal shrinkage ratio in the main shrinkage direction measured under thermal shrinkage conditions of 60° C. to 80° C. and for 10 seconds satisfies the following Relational Expression (1):
$$[ Math . 1 ]$$
$$Thermal shrinkage ratio ( \% ) = a \times ( thermal shrinkage temperature ( ° C . ) - 60 ) + b \qquad ( 1 )$$
a) corresponding to a slope of Relational Expression (1), a value of 3.25 or more and 4 or less, and
b) corresponding to a constant of Relational Expression (1), a value of 0 or more and 5 or less.

4. The heat-shrinkable polyester film according to claim 1, having a property (D5′) in which a thermal shrinkage ratio in the main shrinkage direction measured under thermal shrinkage conditions of 60° C. to 80° C. and for 10 seconds satisfies the following Relational Expression (2):
$$[ Math . 2 ]$$
$$Thermal shrinkage ratio ( \% ) = {a}^{′} \times ( thermal shrinkage temperature ( ° C . ) - 60 ) + {b}^{′} \qquad ( 2 )$$
a′) corresponding to a slope of Relational Expression (2), a value of 3.3 or more and 3.75 or less, and
b′) corresponding to a constant of Relational Expression (2), a value of 0 or more and 5 or less.

5. The heat-shrinkable polyester film according to claim 1, having a property (D5″) in which a thermal shrinkage ratio in the main shrinkage direction measured under thermal shrinkage conditions of 60° C. to 80° C. and for 10 seconds satisfies the following Relational Expression (3):
$$[ Math . 3 ]$$
$$Thermal shrinkage ratio ( \% ) = {a}^{′′} \times ( thermal shrinkage temperature ( ° C . ) - 60 ) + {b}^{′′} \qquad ( 3 )$$
a″) corresponding to a slope of Relational Expression (3), a value of 3.35 or more and 3.5 or less, and
b″) corresponding to a constant of Relational Expression (3), a value of 0 or more and 5 or less.

6. The heat-shrinkable polyester film according to claim 1, having a property (D6) in which a thermal shrinkage ratio in a direction perpendicular to the main shrinkage direction measured under thermal shrinkage conditions of 70° C. and for 10 seconds is a value in a range of −3 to 5%.

7. The heat-shrinkable polyester film according to claim 1,
wherein a thickness of the film is set to a value in a range of 10 to 100 μm and the standard deviation of the thickness measured under predetermined conditions is 1.7 μm or less.

8. The heat-shrinkable polyester film according to claim 1,
wherein the polyester resin is a mixture of a crystalline polyester resin and an amorphous polyester resin, and a weight mixing ratio is a value in a range of 100:0 to 80:20.
